(19) United States
(12) Patent Application Publication
(10) Pub. No.: US 2014/0253638 A1
(43) Pub. Date: Sep. 11, 2014

(54) Device for Discharging Ink Using Electrostatic Force

(71) Applicant: Su Jung Kim, Seoul (KR)

(72) Inventor: Su Jung Kim, Seoul (KR)

(73) Assignee: Enjet Co., Ltd., Gyeonggi-do (KR)

(21) Appl. No.: 14/352,353

(22) PCT Filed: Aug. 24, 2012
(86) PCT No.: PCT/KR2012/006737

§ 371 Date: Apr. 17, 2014

(30) Foreign Application Priority Data
Oct. 17, 2011 (KR) 1020110106070

(51) Int. Cl. B41J 2/06

(52) U.S. Cl. CPC B41J 2/06
USPC 347/55

(57) ABSTRACT

Provided herein is a device for discharging ink using electrostatic force, the device including a nozzle portion for discharging ink through an electric field to a substrate; an electrode portion for creating an electric field between the nozzle and the substrate; and a gas discharge portion for discharging guide gas from outside of the nozzle portion to control a cross-section area of ink being discharged from the nozzle portion.

### BACKGROUND

1. Field

The following description relates to a device for discharging ink using electrostatic force, and more particularly to a device for discharging ink using electrostatic force capable of printing a pattern of a finer line width.

2. Description of Related Art

Generally, devices for discharging ink have been applied to inkjet printers, and they are recently being adapted and developed to be applied to high value product fields such as the display manufacturing process, printed circuit board manufacturing process, and DNA chip manufacturing process.

Ink discharging devices in the inkjet printer field of related art for discharging ink in the form of droplets are mainly piezo driving type and thermal driving type ink discharging devices. However, both the piezo driving type and the thermal driving type ink discharging devices have limitations in terms of the size of droplets due to limitations of the driving energy, and especially, thermal driving type ink discharging devices are not suitable for large area printing due to thermal problems and possible deformation of material.

In order to resolve this problem, devices for discharging ink using electrostatic force are being developed.

In general, a device of related art for discharging ink using electrostatic force may have an electrode for supplying electric charges to the ink provided inside a nozzle, and a counter electrode facing the electrode, wherein a voltage may be applied between the electrodes, creating an electric field therebetween to make the ink form a meniscus at a nozzle end portion. Then the device may operate such that the ink that formed a meniscus is discharged to a substrate by Coulomb's Force.

However, with such a device of related art for discharging ink using electrostatic force, in order to make the line width of the patterns to be formed on the substrate more finer, the size of the nozzle must be reduced, which would significantly increase the cost and time for manufacturing fine size nozzles.

Furthermore, even when using a fine size nozzle, if the ink to be discharged has a high viscosity, the nozzle may be frequently clogged with the ink, thereby increasing the defection rate of the pattern being formed and the cost for repair and maintenance of the discharging device.

Furthermore, the characteristics of the ink such as volatility and surface tension and the like may affect the shape to be patterned on the substrate resulting in a substrate that lacks smoothness, and there may be droplets discharged from the nozzle or continuously discharged particles of ink in the form of jets scattered around the pattern.

### SUMMARY

Therefore, the purpose of the present disclosure is to resolve the aforementioned problems of related art, that is, to provide a device for discharging ink using electrostatic force, the device characterized in that droplets formed in a nozzle or ink being discharged therefrom are controlled by discharging guide gas to make the diameter or line width of a pattern hit on the substrate finer.

In a general aspect, there is provided an ink discharging device using electrostatic force, the device comprising: a nozzle portion for discharging ink through an electric field to a substrate; an electrode portion for creating an electric field between the nozzle and the substrate; and a gas discharge portion for discharging guide gas from outside of the nozzle portion to control a cross-section area of ink being discharged from the nozzle portion.

In the general aspect of the ink discharging device, the ink may form a meniscus at an end portion of the nozzle portion by means of the electric field created by the electrode portion, and then may be discharged as droplets, and the gas discharge portion may control the meniscus of the ink by discharging the guide gas towards the meniscus of the ink formed at the end portion of the nozzle portion.

In the general aspect of the ink discharging device, the gas discharge portion may control a diameter of the ink droplets being discharged by discharging the guide gas towards the droplets being discharged from the nozzle portion.

In the general aspect of the ink discharging device, the ink may be discharged continuously from the nozzle portion, and the gas discharge portion may control a diameter of a cross-section of the ink being discharged by discharging the guide gas towards the ink being continuously linearly discharged from the nozzle.

In the general aspect of the ink discharging device, the outer diameter of the nozzle portion may decrease towards where the ink is discharged, and the gas discharge portion may comprise a space housing configured to be distanced from the nozzle portion and surrounding the nozzle portion, the gas discharge portion discharging the guide gas through a gas flow path formed between the nozzle portion and the space housing.

In the general aspect of the ink discharging device, there may be further provided a controller configured to control the guide gas being discharged from the gas discharge portion to control a cross-section area of the ink being discharged.

In the general aspect of the ink discharging device, the controller may control a discharge speed of the guide gas being discharged from the gas discharge portion.

In the general aspect of the ink discharging device, the controller may control a discharge direction of the guide gas being discharged from the gas discharge portion.

According to the present invention, it is possible to provide a device for discharging ink using electrostatic force, the device being capable of making the diameter or line width of ink discharged from a nozzle portion finer without having to making the size of the nozzle portion finer.

In addition, even when using ink of high viscosity, it is possible to make the line width of the pattern being formed on the substrate finer.

Furthermore, it is possible to adjust the discharge speed or discharge direction so that guide gas can control one of the shape of meniscus and size of droplets formed in the nozzle portion, size of the droplets that are displaced from the meniscus and discharged, and cross-sectional size area of ink being discharged in a straight line direction from the nozzle portion, thereby easily making the line width of the pattern being formed on the substrate finer.

In addition, by breaking-up the form of the droplets or particles of ink having a continuous form being discharged, it is possible to prevent the droplets or particles from being scattered around the desired pattern, thereby improving the definition of the pattern being formed.

### BRIEF DESCRIPTION OF THE DRAWINGS

Throughout the drawings and the detailed description, unless otherwise described, the same drawing reference numerals will be understood to refer to the same elements, features, and structures. The relative size and depiction of these elements may be exaggerated for clarity, illustrating, and convenience.

FIG. 1 is a schematic perspective view of a device for discharging ink using electrostatic force according to a first exemplary embodiment of the present disclosure.

FIG. 2 is a cross-sectional view of a device for discharging ink using electrostatic force of FIG. 1.

FIG. 3 illustrates a process for discharging droplets from a device for discharging ink using electrostatic force of FIG. 1.

FIG. 4 illustrates an operation for controlling a meniscus in a device for discharging ink using electrostatic force of FIG. 1.

FIG. 5 illustrates an operation for controlling the diameter of droplets being discharged from a device for discharging ink using electrostatic force of FIG. 1.

FIG. 6 illustrates an operation for controlling a cross-section size area of ink being continuously discharged from a device for discharging ink using electrostatic force of FIG. 1.

FIG. 7 is a schematic perspective view of a device for discharging ink using electrostatic force according to a second exemplary embodiment of the present disclosure.

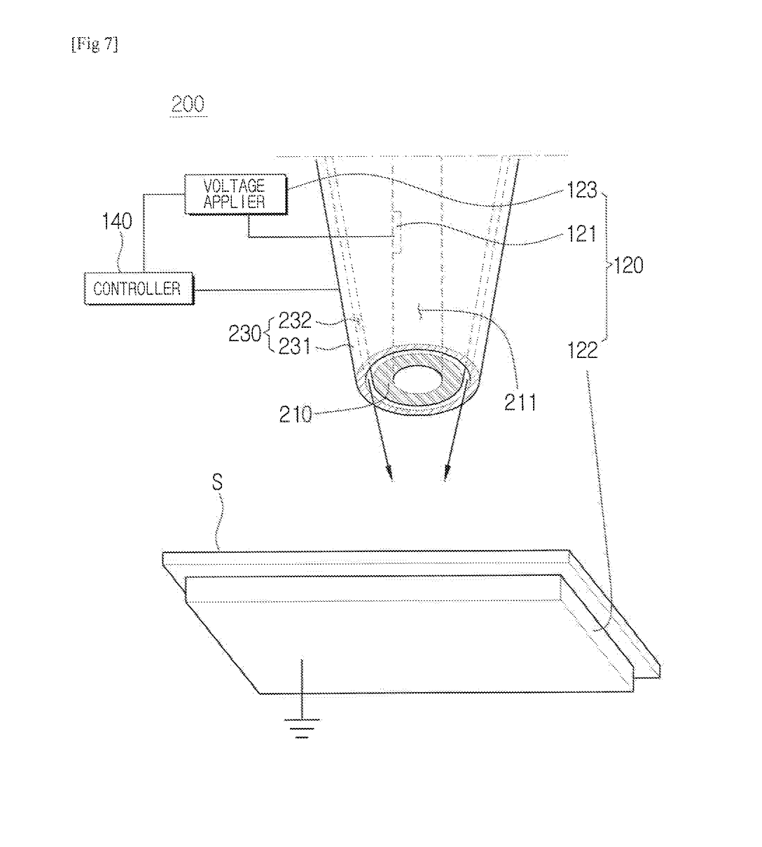

FIG. 8 is a cross-sectional view of a device for discharging ink using electrostatic force of FIG. 7.

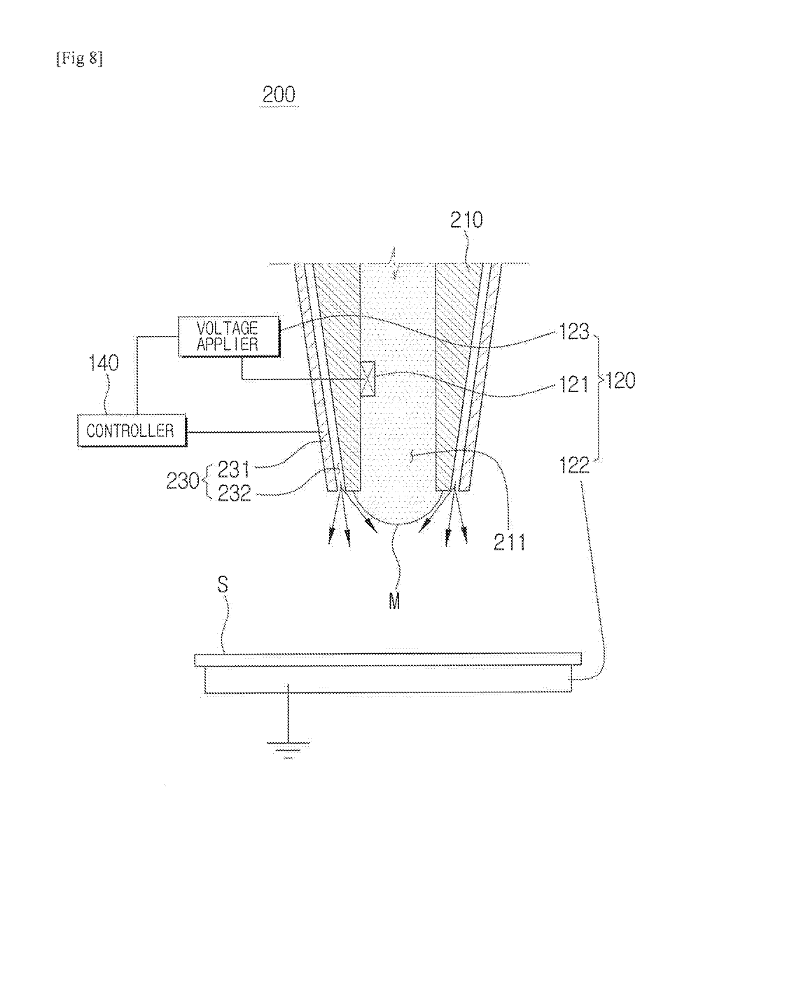

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-know n functions and constructions may be omitted for increased clarity and conciseness.

Hereinbelow, a device for discharging ink using electrostatic force according to a first exemplary embodiment of the present disclosure will be explained in detail with reference to the drawings attached.

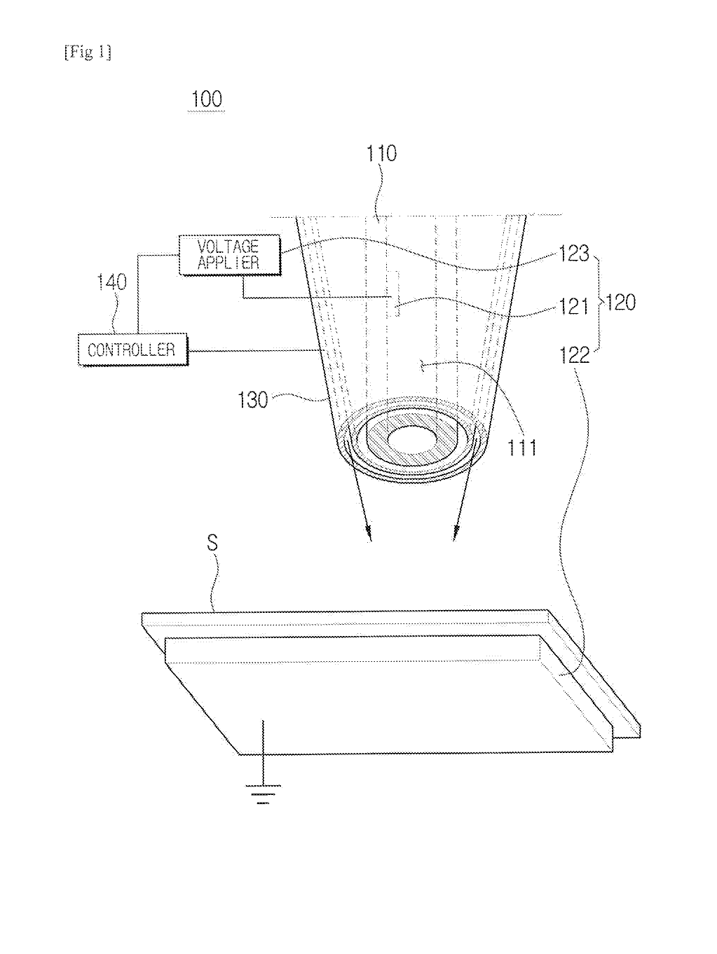

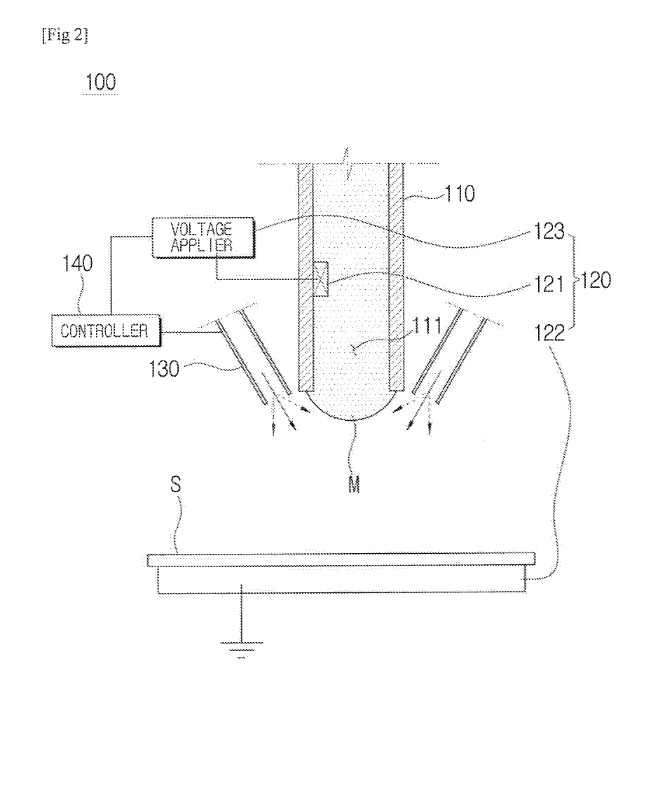

FIG. 1 is a schematic view of a device for discharging ink using electrostatic force according to a first exemplary embodiment of the present disclosure, and FIG. 2 is a cross-sectional view of a device for discharging ink using electrostatic force of FIG. 1.

Referring to FIG. 1, a device for discharging ink using electrostatic force according to a first exemplary embodiment of the present disclosure 100 comprises a nozzle portion 110, electrode portion 120, gas discharge portion 130, and controller 140.

The nozzle portion 110 is disposed opposite a substrate S, and plays a role of discharging ink towards the substrate. The nozzle portion 110 is connected to an external chamber (not illustrated) configured to store ink, and the nozzle portion 110 forms an ink supply path 111 through which ink to be discharged is supplied.

The nozzle portion 110 has an overall shape of a cylinder of which the cross-section is circular having a uniform diameter. Meanwhile, an end of the nozzle portion 110 where a meniscus (M) of the ink supplied from the inner ink supply path 111 is formed will be defined a nozzle tip surface.

The electrode portion 120 is for creating an electric field between the aforementioned nozzle portion 110 and substrate (S) so that ink can be discharged from the nozzle portion 110. The electrode portion 120 comprises a first electrode 121, second electrode 122, and voltage applier 123.

The first electrode 121 is fitted to an inner wall surface of the nozzle portion 110, that is to the ink supply path 111, and is applied with a voltage from the voltage applier 123 that will be explained hereafter.

The second substrate 122 is disposed below the substrate (S) that is opposite the nozzle, and is at a ground condition without being applied with any voltage. That is, according to the aforementioned structure, the substrate (S) is disposed between the second electrode 122 and the nozzle tip surface.

The voltage applier 123 is for applying a voltage of a desired form to the first electrode 121, and the voltage being applied from the voltage applier 123 may be a direct current voltage or alternating current voltage.

However, in the exemplary embodiment, it was explained that the first electrode 121 and the second electrode 122 are disposed in the inner wall surface of the nozzle portion 110 and in a location opposite the nozzle portion 110, respectively, but there is no limitation to where the first electrode 121 and second electrode 122 are disposed as long as they are disposed such that an electric field is created between the nozzle portion 110 and the substrate (S).

The gas discharge portion 130 comprises a pair of cylindrical panels disposed to surround an outer circumference of the aforementioned nozzle portion 110. That is, the cross-section of the gas discharge portion 130 has an annular shape.

The pair of cylindrical panels of the gas discharge portion 130 are spaced from each other, through which guide gas flows and is then discharged towards the nozzle tip surface side. Meanwhile, the diameter of the pair of panels of the gas discharge portion 130 decreases towards the nozzle tip surface side of the nozzle portion 110 so that an area where the guide gas of the gas discharge portion 130 flows form an inclination along the longitudinal direction.

Furthermore, preferably, the end portion side from which the guide gas of the gas discharge portion 130 is discharged is configured to adjust the discharge direction and discharge speed of the guide gas.

The controller 140 is connected to the gas discharge portion 130 and adjusts the discharge direction and discharge speed of the guide gas, whereby the diameter of the meniscus of the ink formed in the nozzle portion 110 or of the ink being discharged from the nozzle portion 110 is controlled.

In addition, the controller 140 is connected to the voltage applier 123 and is configured such that it may control the intensity and form of the voltage applied to the first electrode 121.

An operation of a device for discharging ink using electrostatic force according to first exemplary embodiment 100 will be explained hereafter.

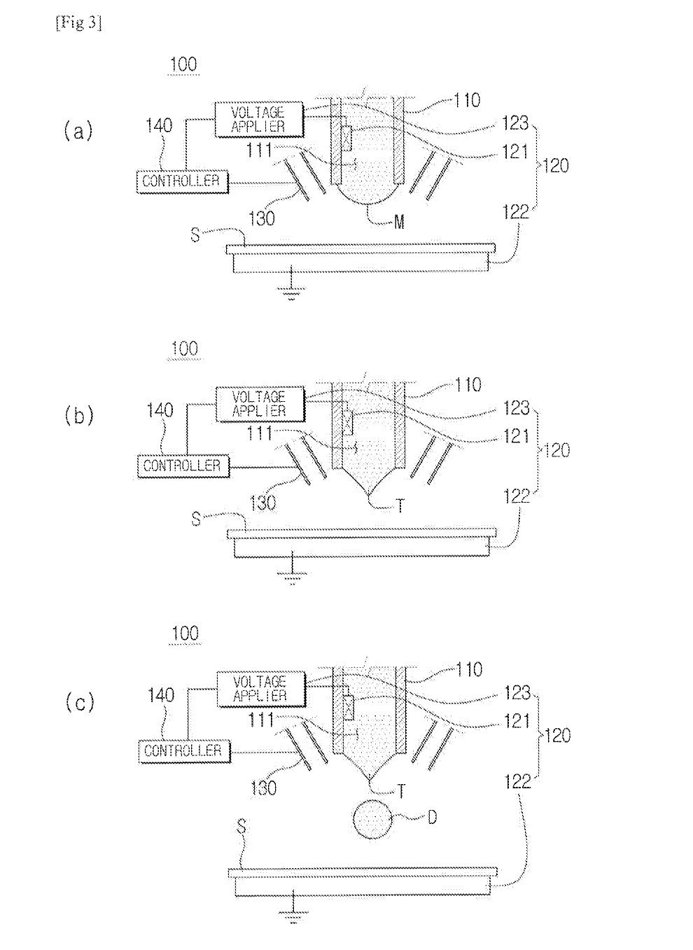

FIG. 3 illustrates a process for discharging droplets from a device for discharging ink using electrostatic force of FIG. 1.

With reference to FIG. 3, first of all, when the controller 140 controls the voltage applier 123 to apply a voltage to the first electrode 121, a potential difference is created between the first electrode 121 and the second electrode 122, while an electric field is created between the nozzle portion 110 where the first electrode 121 is provided and the substrate (S) where the second electrode 122 is provided.

As illustrated in FIG. 3(a), the ink provided from the ink supply path 111 of the nozzle portion 110 forms a meniscus (M) at the end portion of the nozzle tip by means of the electric field formed between the nozzle portion 110 and the substrate (S). Meanwhile, the aforementioned controller 140 may control the intensity of the voltage applied to the first electrode 121, thereby controlling the electric field formed.

As illustrated in FIG. 3(b), when a greater voltage is applied to the first electrode, the form of the ink forming the meniscus (M) on the nozzle tip surface of the nozzle portion 110 changes to a taylor's cone (T).

As illustrated in FIG. 3(c), when the electric field formed between the nozzle portion 110 and the substrate (S) increases above the minimum electric field critical value for the ink to be displaced from the aforementioned taylor's cone (T) and be discharged, the ink is discharged from the nozzle tip surface in the form of droplets (D). The discharged droplets (D) are hit on the opposite substrate (S), forming a pattern of a desired shape on the substrate (S).

Meanwhile, instead of controlling such that droplets (D) are displaced from the nozzle tip surface and are then discharged, thereby forming a pattern on the substrate (S), the controller 140 may control such that a high voltage is applied to the first electrode 121 and the ink is continuously discharged from the nozzle tip, thereby forming a linear pattern on the substrate (S).

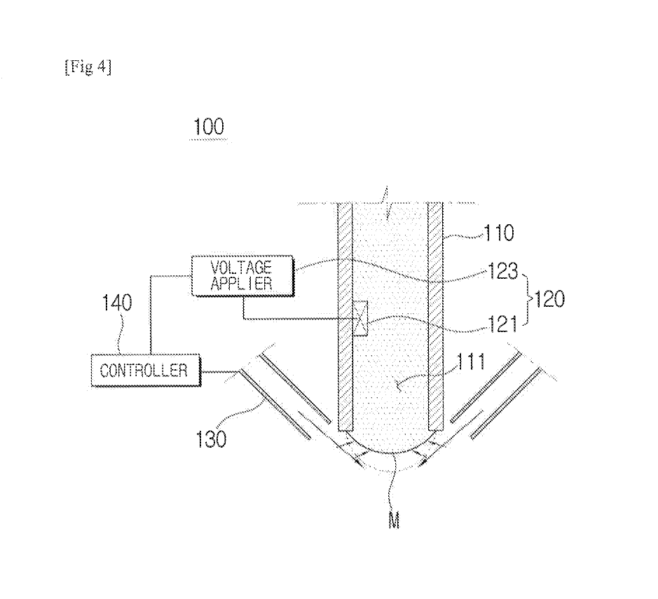

FIG. 4 illustrates an operation for controlling a meniscus in a device for discharging ink using electrostatic force of FIG. 1.

With reference to FIG. 4, regarding the operation of the gas discharge portion 130, during the aforementioned process, the guide gas is supplied and discharged to the outer surface of the nozzle portion 110 and to the space between the pair of panels of the gas discharge portion 130. Meanwhile, the controller 140 controls the gas discharge portion 130 such that the guide gas is discharged towards the meniscus (M) of the ink formed on the nozzle tip surface.

Herein, preferably, the controller 140 controls discharge direction and discharge speed of the guide gas such that the guide gas is discharged symmetrically around the central axis of the nozzle.

The discharged guide gas collides with the meniscus (M) on the nozzle tip surface, changing the shape of the meniscus (M) while reducing the overall size of the meniscus (M) at the same time. Consequently, it is possible to control the diameter of the droplets (M) that are displaced and discharged from the meniscus (M) by controlling the meniscus.

In addition, the controller 140 may also adjust the discharge speed of the guide gas being discharged from the gas discharge portion 130. That is, the controller 140 may control the size of the meniscus (M) and the diameter of the cross-section of the droplets (D) being discharged therefrom by controlling the kinetic energy of the guide gas colliding with the meniscus (M).

Meanwhile, the controller 140 may also adjust the discharge direction of the guide gas being discharged from the gas discharge portion 130. That is, the controller 140 may control the shape and size of the meniscus by controlling the location where the meniscus (D) collides with the guide gas.

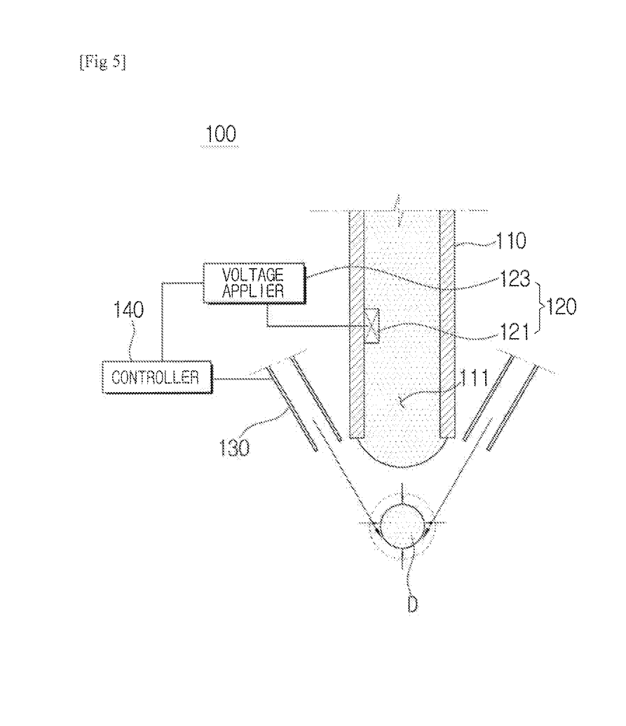

FIG. 5 illustrates an operation for controlling the diameter of droplets being discharged from a device for discharging ink using electrostatic force of FIG. 1.

Not only that, as illustrated in FIG. 5, the controller 140 may control the diameter of the droplets (D) by controlling the guide gas to be directed not towards the meniscus (M) but towards the droplets (D) being displaced from the meniscus (M) and discharged such that the guide gas directly collides with the droplets (D).

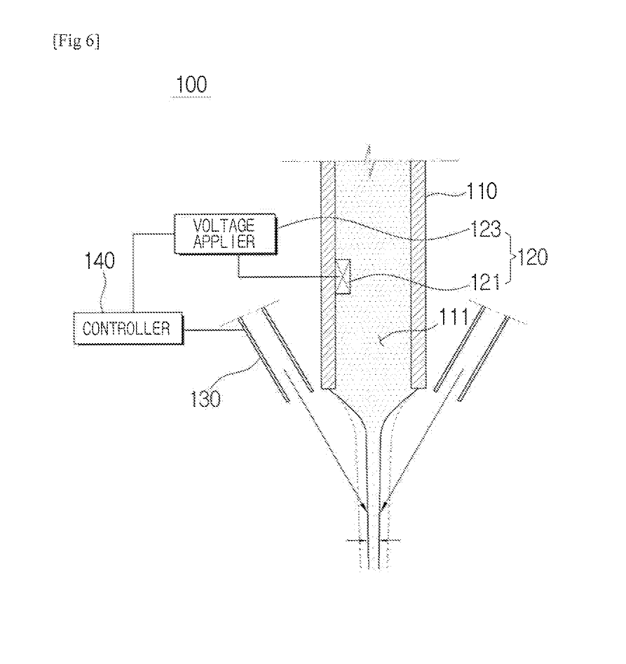

FIG. 6 illustrates an operation for controlling a cross-section size area of ink being continuously discharged from a device for discharging ink using electrostatic force of FIG. 1.

In addition, as aforementioned, even when the ink is continuously discharged linearly as in FIG. 6, and not in the form of droplets (D) from the nozzle tip surface, the controller 140 may control the line width of the pattern formed on the substrate (S) by controlling the gas discharge portion 130 such that the guide gas directly collides with the ink being continuously discharged.

Therefore, according to the device for discharging ink using electrostatic force of the exemplary embodiment 100, it is possible to discharge the guide gas to the meniscus (M) formed on the nozzle tip surface and control the meniscus (M), or make the size or line width of the pattern finally formed on the substrate (S) finer or by directly discharging the guide gas to the droplets (D) being discharged or the ink being discharged in continuous forms from the nozzle portion 110.

In addition, according to the present exemplary embodiment, even when discharging ink of high viscosity, it is possible to make the line width of the pattern being formed on the substrate (S) finer, thereby enabling high quality patterning.

In addition, according to the present exemplary embodiment, it is possible to form a clear pattern since the guide gas can prevent breaking-up of ink, thereby preventing the ink from being scattered on the desired pattern on the substrate.

Next, a device for discharging ink using electrostatic force according to a second exemplary embodiment of the present disclosure 200 will be explained hereafter.

A device for discharging ink using electrostatic force according to a second exemplary embodiment of the present disclosure 200 comprises a nozzle portion 210, electrode portion 120, gas discharge portion 230, and controller 140. The electrode portion 120 and controller 140 have the same configurations as in the first exemplary embodiment and thus repeated explanation is omitted.

The nozzle portion 210 is disposed opposite the substrate (S), and discharges ink towards the substrate (S). It is connected to a predetermined chamber configured to store ink, and forms an ink supply path 211 through which ink to be discharged is supplied. Meanwhile, an end of the nozzle portion 210 where a meniscus (M) of the ink supplied from the inner ink supply path 211 is formed will be defined a nozzle tip surface.

Meanwhile, the outer diameter of the nozzle portion 210 decreases towards the nozzle tip surface, and there may be provided a gas flow path 232 of the guide gas that forms an inclination between it and a space housing 231 that will be explained hereafter.

The gas discharge portion 230 is for discharging the guide gas, and comprises the space housing 231 and the gas flow path 232.

The space housing 231 accommodates the nozzle portion 110 therein, its inner surface spaced from the nozzle portion 210 by a constant distance. Meanwhile, the space housing 231 is configured to have a uniform thickness, and the inner diameter of the space housing 231 also decreases towards the end portion from which the guide gas is discharged so that it is spaced from the outer surface of the nozzle portion 210 forming the inclination by a constant distance.

The gas flow path 232 is a distanced space between the inner surface of the aforementioned space housing 231 and the outer surface of the nozzle portion 210 through which the guide gas can flow. Meanwhile, the width of the gas flow path 232 and the distance between the nozzle portion 210 may preferably be determined in consideration of the type of guide gas being discharged and the type of ink being discharged from the nozzle portion 210.

A number of examples have been described above. Nevertheless, it will be understood that various modifications may be made. For example, suitable results may be achieved if the described techniques are performed in a different order and/or if components in a described system, architecture, device, or circuit are combined in a different matter and/or replaced or supplemented by other components or their equivalents. Accordingly, other implementations are within the scope of the following claims.

### INDUSTRIAL FEASIBILITY

Provided herein is a device for discharging ink using electrostatic force capable of discharging guide gas to control droplets formed on a nozzle portion or ink being discharged, whereby the diameter or line width of a pattern being impacted on a substrate can be made finer.

What is claimed is:

1. An ink discharging device using electrostatic force, the device comprising:
nozzle portion for discharging ink through an electric field to a substrate;
an electrode portion for creating an electric field between the nozzle and the substrate; and
a gas discharge portion for discharging guide gas from outside of the nozzle portion to control a cross-section area of ink being discharged from the nozzle portion.

2. The device according to claim 1,
wherein the ink forms a meniscus at an end portion of the nozzle portion by means of the electric field created by the electrode portion, then the ink being discharged as droplets, and
the gas discharge portion controls a shape of the meniscus of the ink by discharging the guide gas towards the meniscus of the ink formed at the end portion of the nozzle portion.

3. The device according to claim 1,
wherein the gas discharge portion controls a diameter of the ink droplets being discharged by discharging the guide gas towards the droplets being discharged from the nozzle portion.

4. The device according to claim 1,
wherein the ink is discharged continuously from the nozzle portion, and
the gas discharge portion controls a diameter of a cross-section of the ink being discharged by discharging the guide gas towards the ink being continuously linearly discharged from the nozzle.

5. The device according to claim 1,
wherein the outer diameter of the nozzle portion decreases towards where the ink is discharged, and
the gas discharge portion comprises a space housing configured to be distanced from the nozzle portion and surrounding the nozzle portion, the gas discharge portion discharging the guide gas through a gas flow path formed between the nozzle portion and the space housing.

6. The device according to claim 1,
further comprising a controller configured to control the guide gas being discharged from the gas discharge portion to control a cross-section area of the ink being discharged.

7. The device according to claim 2,
further comprising a controller configured to control the guide gas being discharged from the gas discharge portion to control a cross-section area of the ink being discharged.

8. The device according to claim 3,
further comprising a controller configured to control the guide gas being discharged from the gas discharge portion to control a cross-section area of the ink being discharged.

9. The device according to claim 4,
further comprising a controller configured to control the guide gas being discharged from the gas discharge portion to control a cross-section area of the ink being discharged.

10. The device according to claim 5,
further comprising a controller configured to control the guide gas being discharged from the gas discharge portion to control a cross-section area of the ink being discharged.

11. The device according to claim 6,
wherein the controller controls a discharge speed of the guide gas being discharged from the gas discharge portion.

12. The device according to claim 7,
wherein the controller controls a discharge speed of the guide gas being discharged from the gas discharge portion.

13. The device according to claim 8,
wherein the controller controls a discharge speed of the guide gas being discharged from the gas discharge portion.

14. The device according to claim 9,
wherein the controller controls a discharge speed of the guide gas being discharged from the gas discharge portion.

15. The device according to claim 10,
wherein the controller controls a discharge speed of the guide gas being discharged from the gas discharge portion.

16. The device according to claim 6,
wherein the controller controls a discharge direction of the guide gas being discharged from the gas discharge portion.

17. The device according to claim 7,
wherein the controller controls a discharge direction of the guide gas being discharged from the gas discharge portion.

18. The device according to claim 8,
wherein the controller controls a discharge direction of the guide gas being discharged from the gas discharge portion.

19. The device according to claim 9,
wherein the controller controls a discharge direction of the guide gas being discharged from the gas discharge portion.

20. The device according to claim 10,
wherein the controller controls a discharge direction of the guide gas being discharged from the gas discharge portion.
